(19) United States
(12) Patent Application Publication
(10) Pub. No.: US 2004/0268267 A1
(43) Pub. Date: Dec. 30, 2004

(54) Methods and apparatus for prompted activation of an inactive control element in graphical user interface, and context-based help therefor

(75) Inventor: Julia E. Moravcsik, El Segundo, CA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/606,025

(22) Filed: Jun. 25, 2003

(51) Int. Cl. G09G 5/00

(52) U.S. Cl. 715/821; 715/709; 715/824

(57) ABSTRACT

A graphical user interface includes control element or other designation portion for selection of a respective control function. The control element includes a designated appearance, graphical indicator, or other representation that indicates the current status of the control element, such as a status condition of inactivity or for interoperability due to one or more secondary settings or conditions. Invocation of the functionality of the control element causes a context-based help dialog to be presented to the user, which informs the user of the basis for the current status condition and which includes a prompt for automated modification or resolution of the secondary settings, so as to change the current status condition of the control element to a new status condition that offers the desired control function.

The present invention is directed to graphical user interface (GUI) for an operator-controlled system, and more particularly to methods and apparatus for activation of an inactive control element in a graphical user interface, for increasing user satisfaction and productivity on the same machine in a plurality of different operating modes and control functions.

A system subject to operator control can be operated by way of a graphical user interface. Typically, such an interface is accessed through a display and/or selection panel mounted on, or otherwise connected to, the system. Often, the graphical user interface is accessed through a microprocessor-based computer embedded within the system which operates with an integrated or a stand-alone control panel display device, and often employs one or more input devices subject to manipulation by the user, such as a touchscreen, mouse, or a stylus.

As the costs of various systems have dropped and their versatility has improved, they have been provided with an ever-increasing number of controllable features. Similarly, as users have become comfortable with operating such systems by use of a graphical user interface, the practicality of such systems, and thus the control features necessary for the operation of the devices, have expanded greatly. As such systems become more complex and versatile in operation, the user interface between the system and the operator must necessarily be made as simple and effortless as possible, if full and efficient utilization of the system is to be realized.

For example, graphical user interfaces in the form of a display monitor associated with a cursor-based input system can facilitate the operation of a relatively complex machine to perform more than a single task. Such interfaces allow users to visually determine, for example, the feature set that has been selected prior to starting a task, as well as the status of the machine during execution of the task, and the results of the completion of the task.

In another example, touch-sensitive screen user interface systems typically employs a series of programming menus whereby the operational features are selected by touching the desired control element (such as a miniaturized representation, or icon) displayed on the display screen. The most commonly used pointing device used for selection of features on a touch sensitive screen is a finger. Due to the size of the average finger, and due to errors in positioning the finger, it has been found necessary to construct menus of selectable features using relatively large touch sensitive zones for each selectable item on the menu. When combined with a rather limited display area, there is only a limited number of control elements that can be simultaneously displayed for possible selection on a specific display frame area. Even with resort to a smaller pointing device, such as a stylus, it is nevertheless desirable to provide an ever increasing number of feature sets and items for selection. However, reducing the selectable elements in size and making the density of such elements results in greater difficulty in readability and in making selections, and increases accidental selection of an unwanted feature.

Systems such as reprographic or image-forming machines, including digital printing machines or copiers, are widely used in the general office environment. Usually such machines are used in this environment on a non-dedicated and casual basis, as well as by users of varying skill levels, including the most basic level. At the same time, such digital printing machines or copiers are also being used by highly skilled and experienced operators, in a dedicated manner, within, for example, the centralized reprographic departments (CRD's) of large corporations or in key operator Quick Printing Shops.

A suitable graphical user interface must therefore not only provide the controls, displays, and messages necessary to activate, program, monitor, and maintain the machine, but it must also provide a level of messages and operator prompts for a wide range of trained an untrained operators to accurately and efficiently program the machine for various tasks. A primary concern is the smooth transition of a novice operator through the various successive control operations, so as to avoid the distraction and alienation resulting from a screen that presents an overwhelming display of elements and text messages, which leads the novice operator into misguided or error-prone operation, if not a state of confusion on how to proceed.

Furthermore, a given model of a machine can be made by a single manufacturer and be intended for use in one or several differing environments, such as the home, the general office environment, or the CRD environment. Ordinarily, the manufacturer must compromise between an attempt to optimize the GUI on each such model for a particular market environment, or to optimize the GUI for a variety of market environments. However, as pointed out above, the skill levels and work practices of the actual machine users or operators may differ greatly between such market environments.

While even unsophisticated users of these machines find it easy and intuitive to use the physical control elements, such as push buttons or knobs on a control panel, to control some functions of complex devices that have such a control panel, even those users who are familiar with the various common aspects of many graphical user interfaces find it difficult and non-intuitive to use certain control elements in graphical user interfaces to control even simple functions of some machines. This problem may be understood as follows.

The conventional graphical user interface typically offers a hierarchy of selectable control elements such as icons, buttons, tabs, that are often organized in menus, frames, or other systematic arrangements. As these control elements typically represent one or more settings, conditions, or other status conditions, the graphical user interface must necessarily represent that the status of a control element that may be, at a given moment, inactive or otherwise not available to the operator. The conventional approach to such representation is to provide a graphical representation of the control element in such a way as to visually indicate its current status. An inactive control element, for example, is typically displayed according to a scheme for presenting a “grayed-out” or similar appearance, so as to indicate that the control element is not available to the user. Hence, in the conventional graphical user interface, the user is presented with little or no additional information as to the basis or reason for such current status of an inactive control element. In some approaches, if even a small amount of information as to such basis is displayed as, for example, a warning notice positioned adjacent to the control element, the overall organization of the GUI becomes cluttered and much less functional. In an alternative approach, a minimal amount of information might be revealed by hovering a cursor over an inactive control element; such information will typically be in the form of a terse statement to the user that that is concise enough in order to not obscure other information, indicating that the control element is simply not available.

Further, in the conventional operation of a GUI, should the user precede to “point and click” the desired control element, or to touch the relevant icon (on a touchscreen display), the user is of course blocked from accessing the desired functionality of the inactive control element, even though the attempt to activate or otherwise take advantage of such functionality is readily discernible by the system. A novice or otherwise uninformed user is then forced to determine, without any assistance from the system, what recourse may be taken to determine the basis for the inactive status, and what steps might be necessary to modify or correct such a basis, in order to activate the control element. When faced with such a daunting task, the typical user response ranges from irritation to frustration to anger. Some users fail to ever obtain the desired functionality, while others only obtain it only after a lengthy, time-consuming, and inefficient amount of effort, as for example, by proceeding to manually search a help directory.

There is therefore a need for an improved graphical user interface operable for increasing user satisfaction and productivity on the system for which the graphical user interface provides one or more control elements, wherein such control elements are subject to certain status conditions, such as an inactive or unavailable condition.

In accordance with the present invention, there is provided an improved graphical user interface (GUI) for increasing user satisfaction and productivity. The graphical user interface includes a display screen for displaying user dialog information; a series of system process control and user interactive functional features for operator access to control the operation of the system; a plurality of different optimized user dialog information display modes, such modes being responsive to the status of one or more control elements and their respective presence or absence of user interactive functional features for displaying such control elements on the display screen; an associated controller; and an input device for selectively switching from one to another of the plurality of different optimized user dialog information display modes; thereby enabling increased user satisfaction and user productivity.

In various exemplary embodiments of the systems, methods, and graphical user interfaces according to this invention, a graphical user interface includes a control element having a graphical representation that indicates a current status of the control element. The appearance of at least a portion of the control element is altered to reflect the status currently set for the control element relative to the available functionality of the control element.

In exemplary embodiments, a context-sensitive help text is displayed in response to an attempt by the user to invoke the functionality of a control element when the current status of the control element is a respective first status in a predetermined set of status conditions. When the context-sensitive help text is provided, a prompt to a selected control element is also provided to enable the user to select, upon use of the selected control element, an automated procedure so as to change the current status of the control element to a second status in the predetermined set of status conditions. Invocation of the automated procedure causes the status of the control element to be changed to the second status and to provide a corresponding change in the appearance of the control element so as to indicate the changeover to the second status. In preferred embodiments, the first status conditions is an inactive condition and the second status conditions is an active condition.

In a particular embodiment of the present invention, a graphical user interface is provided which has a plurality of screens, wherein one of the screens is a first screen. The first screen has a plurality of activatable areas corresponding to a subset of a set of preset feature values and inactivatable areas corresponding to a second screen associated with respective preset feature values. A controller within the system determines if an inactivatable area corresponding to the second screen is engaged. The user interface displays an intermediate screen and in response to engagement of the automated help function, the intermediate screen is removed and the main screen displays the formerly inactivatable areas as activatable areas, such that each preset feature value within the set of preset feature values has an activatable area associated therewith.

These and other features and advantages of this invention are described in or are apparent from the following detailed description of various embodiments of the systems, methods and graphical user interfaces according to this invention.

Various exemplary embodiments of this invention will be described in detail, with reference to the following figures.

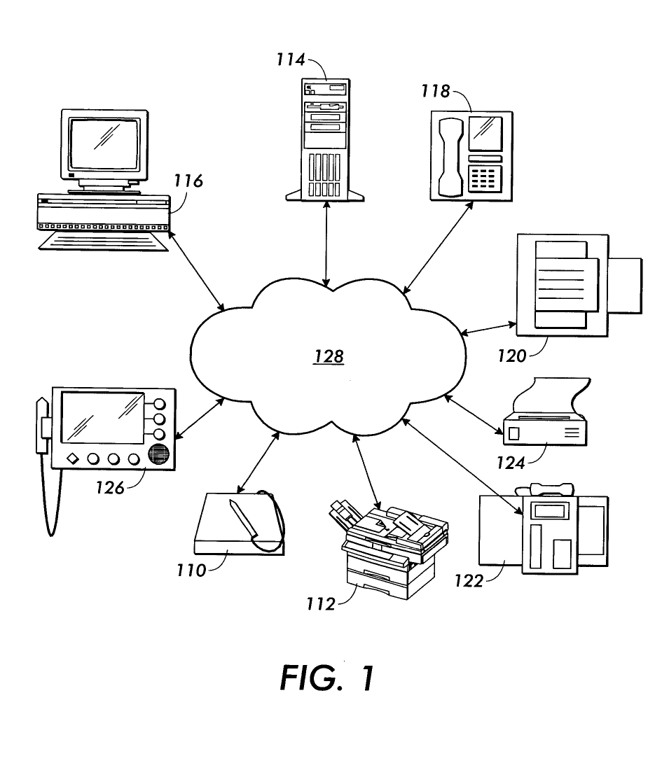

FIG. 1 illustrates a variety of systems which may benefit from the operation of a improved graphical user interface operated according to the present invention;

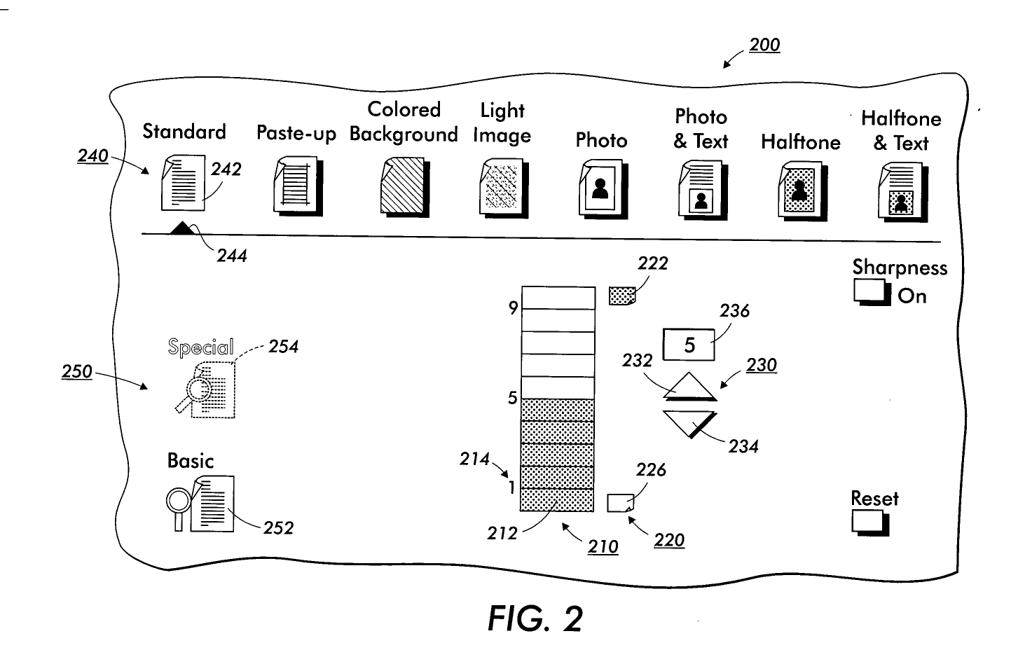

FIG. 2 illustrates a first exemplary embodiment of a graphical user interface having at least one control element in a graphical control panel, suited for operation in an image forming or capture device;

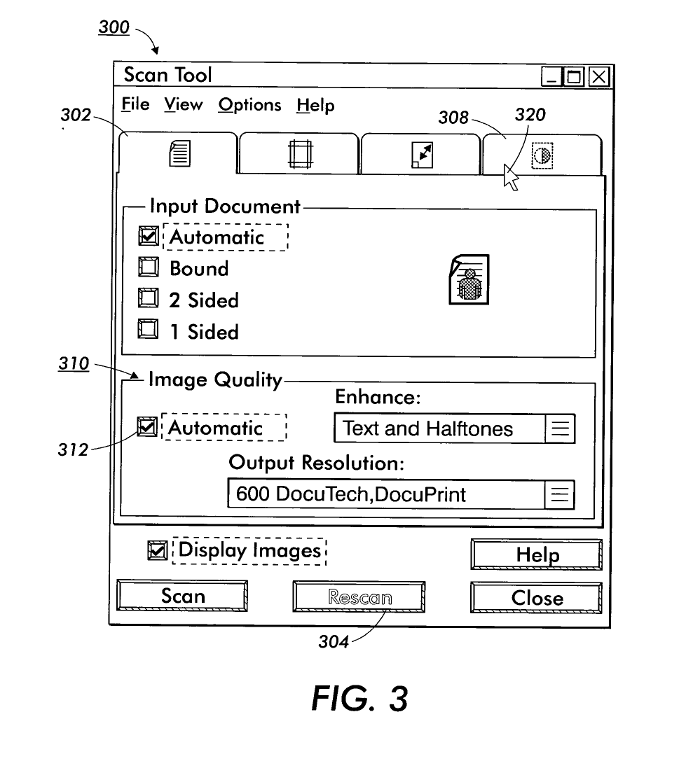

FIG. 3 illustrates a second exemplary embodiment of a graphical user interface, similar to the embodiment of FIG. 2, which is operable according to this invention in a first mode;

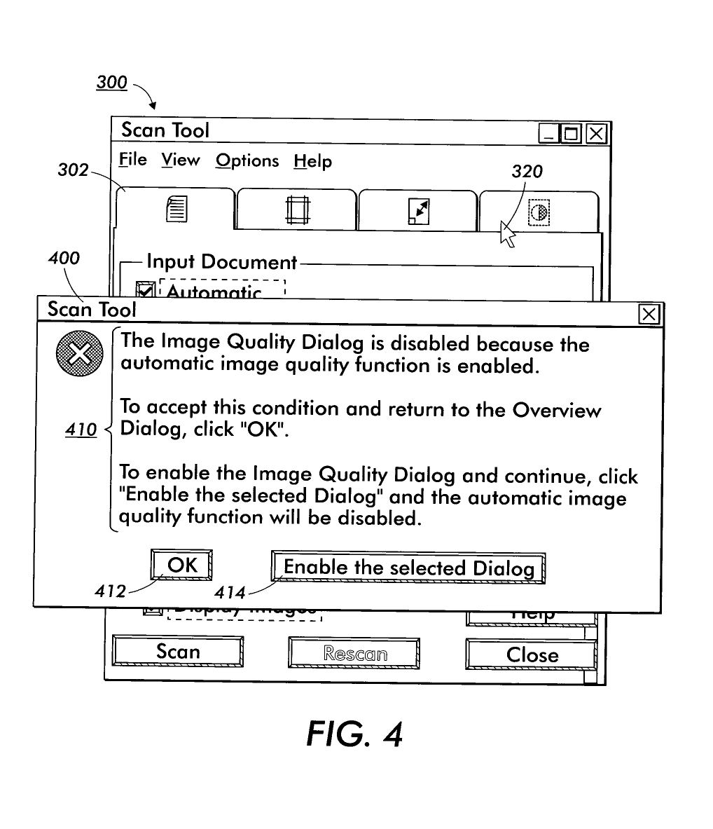

FIG. 4 illustrates the graphical user interface of FIG. 3, operable according to this invention in a second mode;

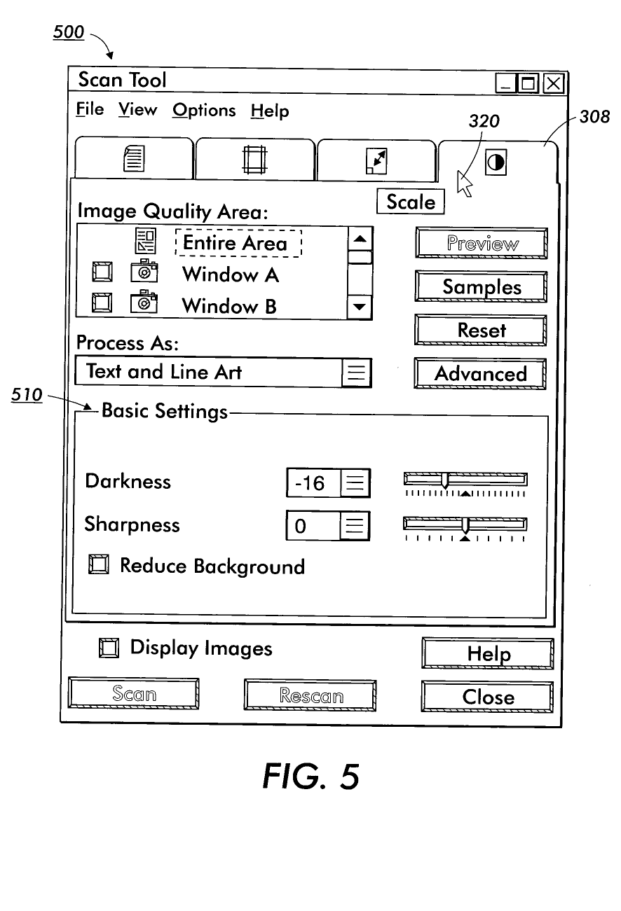

FIG. 5 shows the graphical user interface of FIG. 3, operable according to this invention in a third mode; and

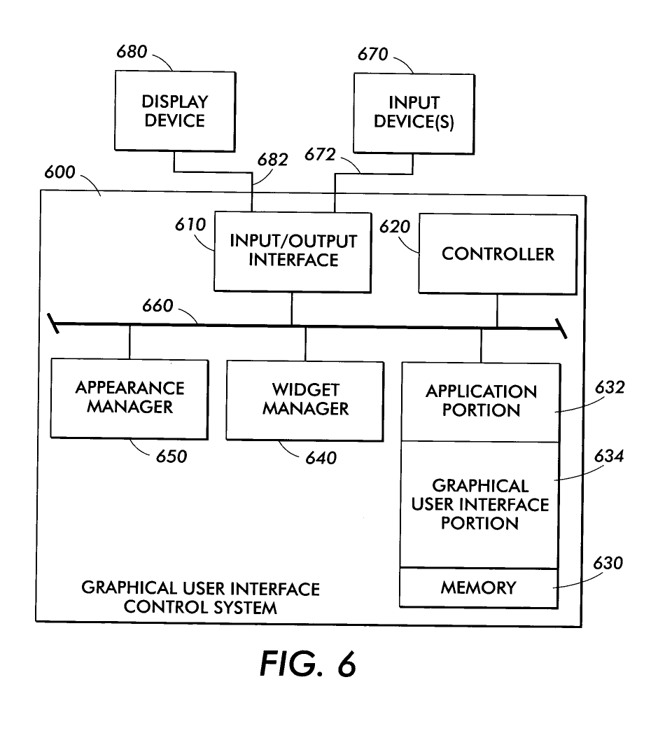

FIG. 6 is a block diagram illustrating one exemplary embodiment of the structural organization of a control system that is usable to control the graphical user interface of FIG. 3.

The graphical user interface and the systems, methods, and interface control systems constructed according to this invention are particularly useful in one or more reprographic apparatus described herein. However, it should be appreciated that the graphical user interface and the systems, methods and interface control systems of this invention can be used for any known or later developed graphical user interface in any known or later developed system. Accordingly, it should be appreciated that, while the following discussion discloses a particular use for the graphical user interface according to the invention, such references are exemplary only, and should not be construed as limiting the scope of this invention.

FIG. 1 illustrates a variety of exemplary embodiments of operator-controlled or operator-responsive systems which may be operable on a network 128 and which can benefit from operation of a graphical user interface operated according to the present invention. Such systems include a pen-based input device such as a handheld computer or personal digital assistant 110, a multifunction reprographic apparatus 112, a remote CPU 114, a desktop computer 116, a communications device 118, an image capture device such as a document scanner 120, a facsimile machine 122, a printer 124, and an analytical instrument 126.

FIG. 2 illustrates first graphical control panel 200. In particular, it should be appreciated that the graphical control panel 200 can be displayed on a cathode ray tube (CRT) type monitor, flat-panel display, touch screen, or any other display device associated with a control function of a operator-controlled system. As shown in FIG. 2, the control panel 200 includes a variety of control elements including an indicator portion 210, a visual cue portion 220, and a control device portion 230, a function selection portion 240, and a function menu selection portion 250.

The indicator portion 210 includes a plurality of visual indicators 212 and a number of numerical visual cues 214. The visual cue portion 220 includes a pair of visual cues 222 and 226. In the illustrated embodiment, the graphical control panel 200 is suited for operation in any digital copier wherein visual cue 222 represents that an output image will be darker than the input image, while the visual cue 226 indicates that the output image will be lighter than the input image. The control device portion 230 of the control panel 200 includes an increase value control button 232 and a decrease control value button 234. The control device portion 230 also includes a numerical portion 236 that numerically indicates the control value that is visually indicated by the visual indicators 212 of the indicator portion 210.

In particular, as the increase and decrease control value buttons 232 and 234 are operated, the numerical value in the numerical portion 236 respectively increases or decreases. At the same time, the particular ones of the visual indicators 212 that are above or below the control value take on different visual appearances. As shown in FIG. 2, the indicator portions 212 that represent control values below the current selected control value, as represented by the number in the numerical portion 236, are given a predetermined color, while the visual indicators 212 that represent numerical values above the currently selected control value are given a differing color appearance.

The function selection portion 240 includes a plurality of function selection elements 242 that can be selected. The selector 244 is used to indicate which of the function selection elements 242 is currently active. The function menu selection portion 250 allows the user to select between a basic menu selector 252 and an advanced menu selector 254. The basic menu selector 252 causes the function selection elements 242 to be displayed in the function selection portion 240, while the advanced menu selector 254 causes an advance set of function elements (not shown) to be displayed in the function selection portion 240. When selected or activated, certain ones of the control elements, such as function selection elements 242 displayed in the control panel 200, will change in appearance depending on the particular variables associated with the different selection elements 242.

FIG. 3 illustrates a second exemplary embodiment of an improved graphical user interface operable in a first of several operational modes. The graphical user interface includes display of a control panel 300 containing therein a variety of control elements. In particular, this graphical user interface includes a image quality portion 310. The image quality portion 310 includes a check box 312 for setting the status of a particular image quality function (illustrated therein as the “automatic” image quality mode). In particular, the interface 300 includes a cursor 320 and an associated array of control elements such as tabs (including an overview dialog tab 302 and image quality tab 502) and of course check box 312, relative to which the user can move a cursor 320 for performing “point-and-click”selection thereof. As illustrated, the condition of the image quality portion 310 is denoted as being in the “automatic” image quality mode by virtue of the check box 312 already being selected. Certain ones of the control elements, such as a “Rescan” button 304 and the image quality tab 308, are presented with a particular appearance to denote a respective status condition. In the illustrated embodiment these control elements are represented in a “grayed-out” appearance to denote their status as being inactive and therefore their functionality is currently unavailable to the user.

In conventional practice, the control elements represented in a “grayed-out” appearance in a graphical user interface would heretofore offer no functionality to the user until certain conditions of the system operation were altered. In typical situations, the user is unaware of the requisite steps to alter such conditions in order to enable these inactive elements. However, according to a particular feature of the present invention, when the cursor 320 is positioned by the user over the image quality tab 308, and the “point-and-click” functionality is invoked, the user is aided when the graphical user interface changes to a second operational mode that is illustrated in FIG. 4.

FIG. 4 illustrates the second exemplary embodiment of an improved graphical user interface in its second operational mode. A dialog 400 appears in the graphical user interface so as to provide context-sensitive help information 410. The presentation of the context-sensitive help information is responsive to the user's attempt at invoking the functionality of the particular control element (in the illustrated instance, in response to the invocation of the image quality tab 308), and accordingly the user is readily informed as to the basis for the current status of the relevant control element. Furthermore, the context sensitive help information offers the user a prompt directed to a first selectable control element 414 such that the user, in following the prompt by “point-and-click” or similar activation of the first selectable control element 414, can invoke this automated function for modifying the status of the desired control element. Accordingly, the user need not have prior knowledge of the requisite steps for modifying the status, as they are carried out automatically upon activation of the selectable control element 414. Of course, should the user prefer to decline the prompt, a second selectable control element 412 is offered to remove the dialog 400 and restore the graphical user interface to its first operational mode illustrated in FIG. 3. Upon selection of either the first selectable control element 414 or the second selectable control element 412, the dialog 400 disappears.

FIG. 5 illustrates the second exemplary embodiment of an improved graphical user interface in its third operational mode, which is displayed shortly after selection by the user of the prompted automated function, described above with respect to FIG. 4. Accordingly, the control panel 300 is replaced by a modified version 500 which not only represents the image quality dialog 308 in solid (rather than “grayed-out”) appearance, but also offers the functionality, such as the “Basic Settings” function 510, originally desired by the user when first attempting the invocation of the image quality dialog 308.

FIG. 6 is a block diagram illustrating an exemplary embodiment of the structural organization of a control system 600 that is usable to control the graphical user interface according to this invention. As shown in FIG. 6, the control system 600 includes an input/output interface 610, a controller 620, a memory 630, a widget manager 640 and an appearance manager 650, each interconnected by a data/control bus 660. One or more input devices 670 and a display device 680 are connected by links 672 and 682, respectively, to the input/output interface 610.

The input device or devices 670 can include any one or more of a mouse, a keyboard, a touch pad, a track ball, a touch screen, pen-based panel or the like, or any other known or later developed device that is capable of inputting data and control signals over the link 672 to the input/output interface 610. Similarly, the display device 680 can be any known or later developed display device, including a CRT monitor, a flat screen type monitor, an LCD panel, or any other known or later developed device on which the graphical user interfaces according to this invention can be displayed and interacted with using one or more of the input devices 670.

The links 672 and 682 can be any known or later developed devices or systems that connect the one or more input devices 670 and the display device 680, respectively, to the control system 600, including a direct cable connection, a connection over a wide area network or local area network, a connection over an intranet, a connection over an extranet, a connection over the Internet, a connection over the public switched telephone network, a connection over a cellular network, or a connection over any other distributed processing or communications network or system, including both or either wired and wireless systems and/or devices. In general, the links 672 and 682 can each be any known or later developed connection systems or structures usable to connect the one or more input devices 670 and the display device 680, respectively, to the control system 600.

The memory 630 includes an application portion 632 in which an application program and any application files used by that application program can be stored. The graphical user interface portion 634 stores various graphical user interface widgets, including the graphical user interfaces 300, 400, 500 shown in FIGS. 3-5 and as described above.

It should be appreciated that the graphical user interface control system 600 shown in FIG. 6 can be implemented on a general purpose computer. However, it should also be appreciated that the graphical user interface control system 600 shown in FIG. 6 can be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA and/or PAL, or the like. In general, any device, capable of implementing a finite state machine, that is in turn capable of implementing the interfaces shown in FIGS. 3-5, can be used to implement the graphical user interface control system 500

The memory 630 shown in FIG. 6 can include both volatile and/or non-volatile alterable memory or non-alterable memory. Any alterable memory can be implemented using any combination of static or dynamic RAM, a hard drive and a hard disk, flash memory, a floppy disk and disk drive, a writable optical disk and disk drive, or the like. Any non-alterable memory can be implemented using any combination of ROM, PROM, EPROM, EEPROM, an optical CD-ROM disk, an optical ROM disk, such as a CD-ROM disk or a DVD-ROM disk and disk drives, or the like.

Thus, it should be understood that each of the elements of the graphical user interface control system 600 shown in FIG. 6 can be implemented as portions of a suitably programmed general purpose computer. Alternatively, each of the elements shown in FIG. 6 can be implemented as physically distinct hardware circuits within a ASIC, or using a FPGA, a PLD, a PLA, or a PAL, or using discreet logic elements or discrete circuit elements. The particular form each of the elements of the graphical user interface control system 500 shown in FIG. 6 will take as a design choice and will be obvious and predictable to those skilled in the art.

Moreover, the graphical user interface control system 600 shown in FIG. 6 can be implemented as software executing on a programmed general purpose computer, a special purpose computer, a microprocessor or the like. In this case, the graphical user interface control system 600 shown in FIG. 6 can be implemented as routines embedded in a peripheral driver, as a resource residing on a server, or the like. The graphical user interface control system 600 shown in FIG. 6 can be implemented by incorporation into a software and/or hardware system, such as the hardware and software systems of a digital copier or the like.

The contemplated operator controlled system has been described herein as typically being manipulated and/or used with the aid of a cursor-enabled graphical user interface. However, other types of graphical user interfaces are contemplated as being within the scope of the present invention, including those operated by touch, stylus, light pen, voice activation, and the like. Such a system may also include or be associated with ancillary devices such as desktop scanners, stand alone scanners, digital still cameras, digital video cameras, facsimile machines, multi-function devices that are capable of generating electronic image data from an original document, digital copiers, digital printers, ink jet printers, and the like.

Operator-controlled or operator-responsive systems, as described herein, are meant to include electronic devices, machines, and appliances that employ a graphical user interface that can be employed in a variety of ways for the benefit of the user. Such systems include electronic devices such as diagnostic, communication, and analytical instrumentation; machines, such as touchscreen kiosks, vending machines, personal computers, copiers, printers, and other image-forming apparatus; and appliances, such as microwaves, remote controls, cameras, telephones, handheld computers, and personal digital assistants (PDA).

What is claimed is:

1. A method for control of an operator-controlled system by a user, comprising the steps of:
providing a graphical user interface in a first mode of operation, wherein a first control element is shown;
receiving an invocation by the user representative of a request for the functionality of the first control element;
determining the current status condition of the control element;
in response to an invocation of the functionality of a control element when the current status of the control element is a respective first status condition among a predetermined plurality of status conditions, changing the graphical user interface to a second mode of operation, wherein context-sensitive help information is provided in the graphical user interface;
providing a prompt to a second control element, the second control element being operable to enable the user to select an automated procedure so as to change the current status of the control element to a second status in the predetermined set of status conditions;
in response to receiving invocation of the automated procedure, performing the automated procedure so as to cause the status of the control element to be changed to a second status condition; and
in response to completion of the automated procedure, changing the graphical user interface to a third mode of operation, wherein the requested functionality of the first control element is made available to the user.

2. The method of claim 1, wherein the first status condition is an inactive control element condition and the second status is an active control element condition.

3. The method of claim 2, further comprising the steps of graphically representing the current status condition of the control element in the graphical user interface.

4. The method of claim 3, further comprising the step of providing a change in the appearance of the control element corresponding to the change from the first status condition to the second status condition.

5. The method of claim 1, further comprising the step of altering the appearance of at least a portion of the control element to reflect the status currently set for the control element relative to the available functionality of the control element.

6. The method of claim 5, wherein the appearance of at least a portion of the control element is grayed-out during a status condition for the control element of inactive functionality.

7. The method of claim 1, wherein the context-sensitive help indicates a basis for the first status condition of the control element.

8. The method of claim 1, further comprising the step of providing a third control element operable by the user for rejecting the prompt and for causing the graphical user interface to return to the first mode of operation.

9. The method of claim 1, wherein the invocation of the functionality of the control element is performed by operation of a cursor-based input system.

10. The method of claim 1, wherein the invocation of the functionality of the control element is performed by operation of a touchscreen input system.
